(19) United States
(12) Patent Application Publication
(10) Pub. No.: US 2025/0267491 A1
(43) Pub. Date: Aug. 21, 2025

(54) METHOD AND DEVICE FOR LOW LATENCY COMMUNICATION IN DENSE ENVIRONMENT

(71) Applicants: HYUNDAI MOTOR COMPANY, SEOUL (KR); KIA CORPORATION, SEOUL (KR); KOREA NATIONAL UNIVERSITY OF TRANSPORTATION INDUSTRY-ACADEMIC COOPERATION FOUNDATION, CHUNGJU-SI (KR)

(72) Inventors: Yong Ho Kim, Incheon (KR); Ju Seong Moon, Osan-si (KR)

(73) Assignees: HYUNDAI MOTOR COMPANY, SEOUL (KR); KIA CORPORATION, SEOUL (KR); KOREA NATIONAL UNIVERSITY OF TRANSPORTATION INDUSTRY-ACADEMIC COOPERATION FOUNDATION, CHUNGJU-SI (KR)

(21) Appl. No.: 18/855,195

(22) PCT Filed: Jul. 3, 2023
(86) PCT No.: PCT/KR2023/009289

§ 371 Date: Oct. 8, 2024

(30) Foreign Application Priority Data
Jul. 1, 2022 (KR) 10-2022-0081224
Mar. 2, 2023 (KR) 10-2023-0028099

(51) Int. Cl. H04W 24/10; H04B 17/309; H04W 74/0816

(52) U.S. Cl. CPC H04W 24/10; H04B 17/346; H04W 74/0816

(57) ABSTRACT

Disclosed are a method and a device for low latency communication in a dense environment. A method of a first STA comprises the steps of: checking a first SP configured by a first AP connected to a first STA; checking a second SP configured by a second AP; checking that the first SP overlaps with the second SP; and transmitting, to the first AP, a measurement report frame indicating the overlap between the first SP and the second SP.

### TECHNICAL FIELD

The present disclosure relates to a wireless local area network (LAN) communication technique, and more particularly, to a technique for configuring a restricted target wake time (R-TWT) in a dense wireless LAN environment.

### BACKGROUND ART

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

The IEEE 802.11ac standard has expanded bandwidths used (e.g., a maximum 160 MHz bandwidth or 80+80 MHz bandwidth) and also increased the number of supported spatial streams. The IEEE 802.11ac standard may refer to a very high throughput (VHT) wireless LAN technology that can support a data rate of over 1 gigabit per second (Gbps). The IEEE 802.11ac standard can utilize MIMO techniques to support downlink transmissions to multiple stations.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multiple access point (AP) transmission operations, and/or efficient retransmission operations (e.g., hybrid automatic repeat request (HARQ) operations).

Multiple links can be used in a wireless LAN, and definition of detailed operations for the wireless LAN that support multiple links may be needed. For example, restricted target wake time (R-TWT) operations for low-latency communication may be defined. In dense wireless LAN environments, periods for low-latency communication (e.g., R-TWT service periods (SPs)) may overlap in the time domain. For instance, a plurality of terminals may attempt communication within R-TWT SPs. In this case, low-latency communication may be disrupted, and the intended low-latency communication may not be performed. Therefore, methods to reconfigure R-TWT SP(s) when the R-TWT SPs overlap in the time domain to prevent such overlap may be required.

Meanwhile, the technologies that are the background of the present disclosure are written to improve the understanding of the background of the present disclosure and may include content that is not already known to those of ordinary skill in the art to which the present disclosure belongs.

### DISCLOSURE

### Technical Problem

The present disclosure is directed to providing a method and an apparatus for changing and/or reconfiguring a restricted target wake time (R-TWT) in a wireless LAN.

### Technical Solution

A method of a first station (STA), according to exemplary embodiments of the present disclosure for achieving the above-described objective, may comprise: identifying a first service period (SP) configured by a first access point (AP) associated with the first STA; identifying a second SP configured by a second AP; determining that the first SP overlaps the second SP; and transmitting a measurement report frame indicating an overlap between the first SP and the second SP to the first AP.

The first SP may be identified based on first target wake time (TWT) configuration information included in a first beacon frame received from the first AP, and the second SP may be identified based on second TWT configuration information included in a second beacon frame or probe response frame received from the second AP.

The measurement report frame may include at least one of information on the second AP or second TWT configuration information for the second SP.

The measurement report frame may be transmitted before the first SP or the second SP if the first SP is predicted to overlap with the second SP, or the measurement report frame may be transmitted after the first SP or the second SP if the first SP is determined to overlap with the second SP.

The method may further comprise: receiving a measurement request frame from the first AP, wherein the measurement request frame may indicate an overlap between the first SP and the second SP, and the measurement report frame may be transmitted when the measurement request frame is received.

The method may further comprise: receiving a third beacon frame including TWT reconfiguration information for the first SP from the first AP; identifying a changed first SP based on the TWT reconfiguration information; and performing communication in the changed first SP, wherein the changed first SP does not overlap with the second SP.

A method of a first access point (AP), according to exemplary embodiments of the present disclosure for achieving the above-described objective, may comprise: transmitting a first beacon frame including first target wake time (TWP) configuration information for a first service period (SP); receiving a measurement report frame from a first STA indicating an overlap between the first SP and a second SP configured by a second AP; and transmitting a second beacon frame including TWT reconfiguration information for the first SP, wherein the first SP changed by the TWT reconfiguration information does not overlap with the second SP.

The measurement report frame may include at least one of information on the second AP or second TWT configuration information for the second SP.

The measurement report frame may be received before the first SP or the second SP if the first SP is predicted to overlap with the second SP at the first STA, or the measurement report frame may be transmitted after the first SP or the second SP if the first SP is determined to overlap with the second SP at the first STA.

The method may further comprise: in response to determining that the first SP and the second SP overlap, transmitting a measurement request frame, wherein the measurement report frame may be received as a response to the measurement request frame.

A method of a first station (STA), according to exemplary embodiments of the present disclosure for achieving the above-described objective, may comprise: identifying a first service period (SP) configured by a first access point (AP) associated with the first STA; detecting overlapped basic service set (OBSS) interference in the first SP; and transmitting a measurement report frame indicating occurrence of the OBSS interference to the first AP.

The first SP may be identified based on first target wake time (TWT) configuration information included in a first beacon frame received from the first AP, and the OBSS interference may be caused by a communication node belonging to an OBSS.

The measurement report frame may include a reason code, and the reason code may indicate occurrence of the OBSS interference.

The method may further comprise: receiving a second beacon frame including TWT reconfiguration information for the first SP from the first AP; identifying a changed first SP based on the TWT reconfiguration information; and performing communication in the changed first SP, wherein the OBSS interference does not occur in the changed first SP.

### Advantageous Effects

According to the present disclosure, low-latency communication between communication nodes (e.g., AP, STA, etc.) may be performed within an R-TWT SP. When R-TWT SPs for multiple communication nodes are configured to overlap in the time domain, low-latency communication may not be achievable. For example, a first communication node may configure a first R-TWT SP, and a second communication node may configure a second R-TWT SP. A third communication node may perform low-latency communication within the first R-TWT SP of the first communication node, while a fourth communication node may perform low-latency communication within the second R-TWT SP of the second communication node.

When the first R-TWT SP and the second R-TWT SP overlap in the time domain, the first communication node can transmit information (e.g., indicator) indicating the overlap of the R-TWT SPs to the third communication node, and the second communication node can transmit information (e.g., indicator) indicating the overlap of the R-TWT SPs to the fourth communication node. Accordingly, the first communication node and/or the second communication node can change and/or reconfigure the R-TWT SP(s) to ensure they do not overlap. Consequently, low-latency communication can be performed within the R-TWT SP, and communication delay can be reduced.

### DESCRIPTION OF DRAWINGS

FIG. 1 is a block diagram illustrating a first exemplary embodiment of a communication node constituting a wireless LAN system.

FIG. 2 is a conceptual diagram illustrating a first exemplary embodiment of a multi-link configured between multi-link devices (MLDs).

FIG. 3 is a timing diagram illustrating a first exemplary embodiment of an R-TWT operation.

FIG. 4 is a conceptual diagram illustrating a first exemplary embodiment of a dense environment.

FIG. 5 is a timing diagram illustrating a first exemplary embodiment of a problem of R-TWT operations in a dense environment.

FIG. 6 is a timing diagram illustrating a first exemplary embodiment of an R-TWT SP reporting method in a dense environment.

FIG. 7 is a timing diagram illustrating a third exemplary embodiment of an R-TWT SP reporting method in a dense environment.

FIG. 8 is a timing diagram illustrating a third exemplary embodiment of an R-TWT SP reporting method in a dense environment.

FIG. 9 is a timing diagram illustrating a first exemplary embodiment of a method for changing an R-TWT SP in a dense environment.

FIG. 10 is a timing diagram illustrating a second exemplary embodiment of a method for changing an R-TWT SP in a dense environment.

FIG. 11 is a timing diagram illustrating a third exemplary embodiment of a method for changing an R-TWT SP in a dense environment.

FIG. 12 is a timing diagram illustrating a first exemplary embodiment of a method for changing R-TWT SP(s) and link(s) in a dense environment.

FIG. 13 is a timing diagram illustrating a second exemplary embodiment of a method for changing R-TWT SP(s) and link(s) in a dense environment.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a wireless communication system to which exemplary embodiments according to the present disclosure are applied will be described. The wireless communication system to which the exemplary embodiments according to the present disclosure are applied is not limited to the contents described below, and the exemplary embodiments according to the present disclosure can be applied to various wireless communication systems. A wireless communication system may be referred to as a ‘wireless communication network’.

In exemplary embodiments, ‘configuration of an operation (e.g., transmission operation)’ may mean that ‘configuration information (e.g., information element(s), parameter(s)) for the operation’ and/or ‘information indicating to perform the operation’ is signaled. ‘Configuration of an information element (e.g., parameter)’ may mean that the information element is signaled. ‘Configuration of a resource (e.g., resource region)’ may mean that setting information of the resource is signaled.

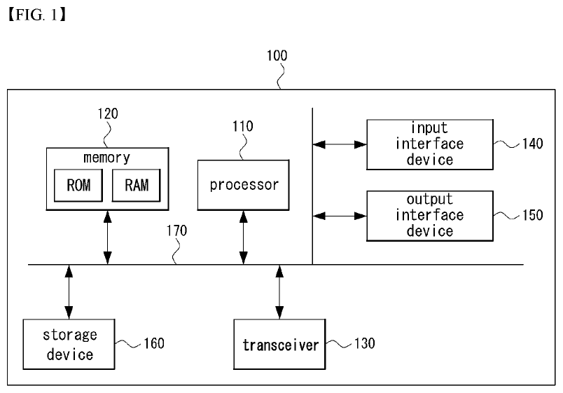

FIG. 1 is a block diagram illustrating a first exemplary embodiment of a communication node constituting a wireless LAN system.

As shown in FIG. 1, a communication node 100 may be an access point, a station, an access point (AP) multi-link device (MLD), or anon-AP MLD. An access point may refer to ‘AP’, and a station may refer to ‘STA’ or ‘non-AP STA’. An operating channel width supported by an AP may be 20 megahertz (MHz), 80 MHz, 160 MHz, or the like. An operating channel width supported by a STA may be 20 MHz, 80 MHz, or the like.

The communication node 100 may include at least one processor 110, a memory 120, and a transceiver 130 connected to a network to perform communications. The transceiver 130 may be referred to as a transceiver, a radio frequency (RF) unit, an RF module, or the like. In addition, the communication node 100 may further include an input interface device 140, an output interface device 150, a storage device 160, and the like. The respective components included in the communication node 100 may be connected by a bus 170 to communicate with each other.

However, the respective components included in the communication node 100 may be connected through individual interfaces or individual buses centering on the processor 110 instead of the common bus 170. For example, the processor 110 may be connected to at least one of the memory 120, the transceiver 130, the input interface device 140, the output interface device 150, and the storage device 160 through a dedicated interface.

The processor 110 may execute program commands stored in at least one of the memory 120 and the storage device 160. The processor 110 may refer to a central processing unit (CPU), a graphics processing unit (GPU), or a dedicated processor on which the methods according to the exemplary embodiments of the present disclosure are performed. Each of the memory 120 and the storage device 160 may be configured as at least one of a volatile storage medium and a nonvolatile storage medium. For example, the memory 120 may be configured with at least one of a read only memory (ROM) and a random access memory (RAM).

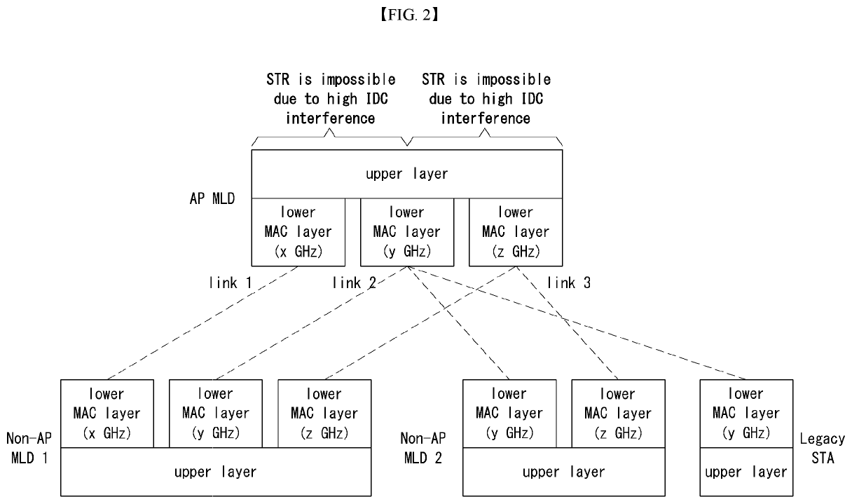

FIG. 2 is a conceptual diagram illustrating a first exemplary embodiment of a multi-link configured between multi-link devices (MLDs).

As shown in FIG. 2, an MLD may have one medium access control (MAC) address. In exemplary embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In exemplary embodiments, a link may mean a channel or a band. A device that does not support the STR operation may be referred to as a non-STR (NSTR) AP MLD or an NSTR non-AP MLD (or NSTR STA MLD).

The MLD may transmit and receive frames in multiple links by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 110 shown in FIG. 1). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 110 shown in FIG. 1).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band, and perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

When a band separation between multiple links (e.g., a band separation between a link 1 and a link 2 in the frequency domain) is sufficient, the MLD may be able to perform an STR operation. For example, the MLD may transmit a physical layer convergence procedure (PLCP) protocol data unit (PPDU) 1 using the link 1 among multiple links, and may receive a PPDU 2 using the link 2 among multiple links. On the other hand, if the MLD performs an STR operation when the band separation between multiple links is not sufficient, in-device coexistence (IDC) interference, which is interference between the multiple links, may occur. Accordingly, when the bandwidth separation between multiple links is not sufficient, the MLD may not be able to perform an STR operation. A link pair having the above-described interference relationship may be a non-simultaneous transmit and receive (NSTR)-limited link pair. Here, the MLD may be referred to as ‘NSTR AP MLD’ or ‘NSTR non-AP MLD’.

For example, a multi-link including a link 1, a link 2, and a link 3 may be configured between an AP MLD and a non-AP MLD 1. When a band separation between the link 1 and the link 3 is sufficient, the AP MLD may perform an STR operation using the link 1 and the link 3. That is, the AP MLD may transmit a frame using the link 1 and receive a frame using the link 3. When a band separation between the link 1 and the link 2 is insufficient, the AP MLD may not be able to perform an STR operation using the link 1 and the link 2. When a band separation between the link 2 and the link 3 is not sufficient, the AP MLD may not be able to perform an STR operation using the link 2 and the link 3.

Meanwhile, in a wireless LAN system, a negotiation procedure for a multi-link operation may be performed in an access procedure between a station and an access point. A device (e.g., access point, station) that supports multiple links may be referred to as ‘multi-link device (MLD)’. An access point supporting multiple links may be referred to as ‘AP MLD’, and a station supporting multiple links may be referred to as ‘non-AP MLD’ or ‘STA MLD’. The AP MLD may have a physical address (e.g., MAC address) for each link. The AP MLD may be implemented as if an AP in charge of each link exists separately. A plurality of APs may be managed within one AP MLD. Therefore, coordination between a plurality of APs belonging to the same AP MLD may be possible. A STA MLD may have a physical address (e.g., MAC address) for each link. The STA MLD may be implemented as if a STA in charge of each link exists separately. A plurality of STAs may be managed within one STA MLD. Therefore, coordination between a plurality of STAs belonging to the same STA MLD may be possible.

For example, an APT of the AP MLD and a STAT of the STA MLD may each be responsible for a first link and perform communication using the first link. An AP2 of the AP MLD and a STA2 of the STA MLD may each be responsible for a second link and perform communication using the second link. The STA2 may receive status change information for the first link on the second link. In this case, the STA MLD may collect information (e.g., status change information) received on the respective links, and control operations performed by the STAT based on the collected information.

Hereinafter, data transmission and reception methods in a wireless LAN system will be described. Even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a STA is described, an AP corresponding thereto may perform an operation corresponding to the operation of the STA. Conversely, when an operation of an AP is described, a STA corresponding thereto may perform an operation corresponding to the operation of the AP.

In exemplary embodiments, operations of a STA may be interpreted as operations of a STA MLD, operations of a STA MLD may be interpreted as operations of a STA, operations of an AP may be interpreted as operations of an AP MLD, and operations of an AP MLD may be interpreted as operations of an AP. A STA of a STA MLD may refer to a STA affiliated with the STA MLD, and an AP of an AP MLD may refer to an AP affiliated with the AP MLD. When a STA MLD includes a first STA operating on a first link and a second STA operating on a second link, operations of the STA MLD on the first link may be interpreted as operations of the first STA, and operations of the STA MLD on the second link may be interpreted as operations of the second STA. When an AP MLD includes a first AP operating on the first link and a second AP operating on the second link, operations of the AP MLD on the first link may be interpreted as operations of the first AP, and operations of the AP MLD on the second link may be interpreted as operations of the second AP. In exemplary embodiments, a transmission time of a frame may refer to a transmission start time or a transmission end time, and a reception time of a frame may refer to a reception start time or a reception end time.

The AP MLD, AP, STA MLD, and/or STA may perform restricted target wake time (R-TWT) operations for low-latency communication. In the present disclosure, the R-TWT operation may be interpreted as a TWT operation, and an R-TWT service period (SP) may be interpreted as a TWT SP. The R-TWT SP and/or TWT SP may be simply expressed as ‘SP’. For example, an R-TWT SP 1 may be referred to as a first SP, and an R-TWT SP 2 may be referred to as a second SP.

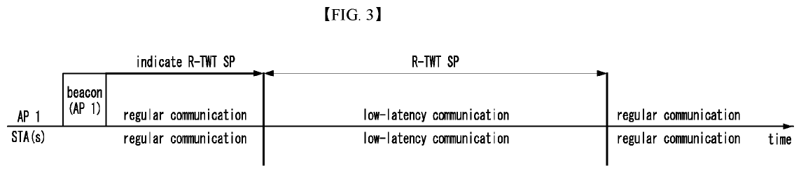

FIG. 3 is a timing diagram illustrating a first exemplary embodiment of an R-TWT operation.

As shown in FIG. 3, an AP 1 may transmit a beacon frame including R-TWT configuration information (e.g., configuration information of an R-TWT SP). In other words, the beacon frame may indicate the R-TWT SP. STA(s) may receive the beacon frame from the AP 1 and may identify information element(s) included in the beacon frame. For example, the STA(s) may identify the R-TWT SP based on the R-TWT configuration information included in the beacon frame. Low-latency communication between the AP 1 and the STA(s) may be performed within the R-TWT SP. Regular communication between the AP 1 and the STA(s) may be performed in a period other than the R-TWT SP.

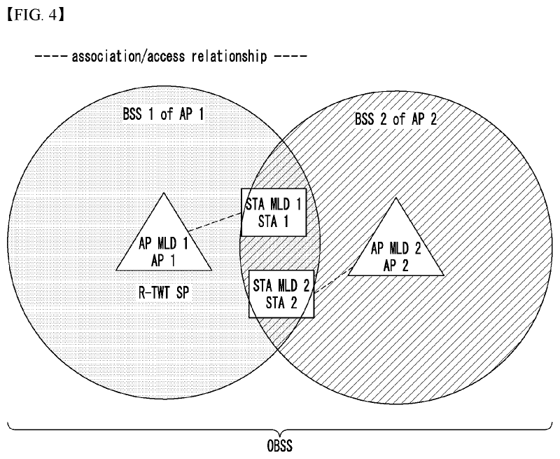

FIG. 4 is a conceptual diagram illustrating a first exemplary embodiment of a dense environment.

As shown in FIG. 4, a STA 1 affiliated with a STA MLD 1 may be associated with and/or access an AP 1 affiliated with an AP MLD 1, and a STA 2 affiliated with a STA MLD 2 may be associated with and/or access an AP 2 affiliated with an AP MLD 2. Alternatively, at least one of the STA 1, STA 2, AP 1, or AP 2 may not be affiliated with an MLD. Alternatively, all of the STA 1, STA 2, AP 1, and AP 2 may not be affiliated with MLD(s). The AP 1 and STA 1 may form a basic service set (BSS) 1, and the AP 2 and STA 2 may form a BSS 2. The BSS may be configured for each link (e.g., link of MLD). For example, the BSS 1 may be configured for a first link, and the BSS 2 may be configured for a second link. The BSS 1 and BSS 2 may support the same frequency (e.g., channel, link). The BSS 1 and BSS 2 may be physically located in close proximity. The BSS 1 and BSS 2 may be overlapping BSSs (OBSS).

Wireless signals may only reach a certain distance due to signal attenuation, obstacles, etc. A communication node (e.g., AP and/or STA) may or may not receive a wireless signal (e.g., communication content) of another communication node. When the AP 1 and AP 2 are located in an interference region, the AP 1 may not be able to receive a wireless signal of the AP 2, and the AP 2 may not be able to receive a wireless signal of the AP 1. In the interference region, the AP 1 may interpret the wireless signal of the AP 2 as noise, and the AP 2 may interpret the wireless signal of the AP 1 as noise. When the AP 1 and AP 2 are located at a far distance, the AP 1 may not be able to receive a wireless signal of the AP 2, and the AP 2 may not be able to receive a wireless signal of the AP 1.

The AP 1 may be a hidden node with respect to the AP 2, and the AP 2 may be a hidden node with respect to the AP 1. The STA 1 and AP 2 may be located in a transmission region where transmission and reception of signals (e.g., data) are possible. In this case, the STA 1 may be able to a wireless signal of the AP 2. If the AP 2 transmits a signal while the STA 1 performs a reception operation for a signal of the AP 1, a collision between the signal of the AP 1 and the signal of the AP 2 may occur in the STA 1. Accordingly, the STA 1 may not be able to receive the signal (e.g., data, frame) of the AP 1. In other words, reception of the signal of the AP 1 at the STA 1 may fail. An error may occur in the signal received from the AP 1 at the STA 1.

If the STA 1 transmits a signal while the AP 2 performs a reception operation for a signal of the STA 2, a collision between the signal of the STA 1 and the signal of the STA 2 may occur at the AP 2. Accordingly, the AP 2 may not receive the signal (e.g., data, frame) of the STA 2. In other words, reception of the signal of the STA 2 at the AP 2 may fail. An error may occur in the signal of the STA 2 received at the AP 2. If the STA 2 and AP 1 are located in a transmission region where transmission and reception of signals are possible, the collision problem described above (e.g., reception failure and/or reception error of the signal) may occur. The AP (e.g., AP 1 and/or AP 2) may be an AP MLD, and the STA (e.g., STA 1 and/or STA 2) may be a STA MLD.

When R-TWT operations are performed in an environment similar to and/or identical to the dense environment illustrated in FIG. 4, the following problem(s) may occur.

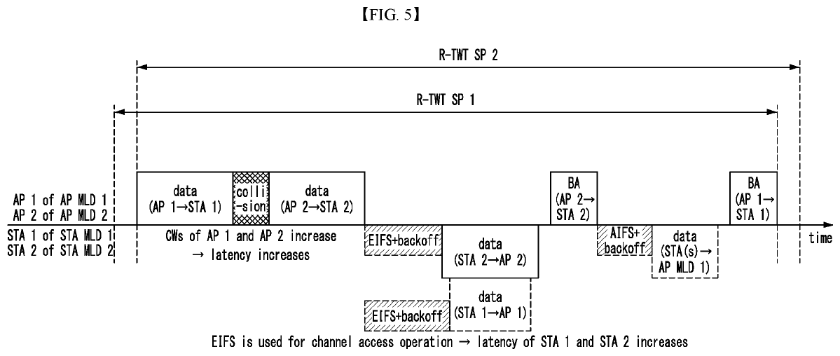

FIG. 5 is a timing diagram illustrating a first exemplary embodiment of a problem of R-TWT operations in a dense environment.

As shown in FIG. 5, the AP MLD 1, AP MLD 2, AP 1, AP 2, STA MLD 1, STA MLD 2, STA 1, and STA 2 may be arranged identically or similarly to the exemplary embodiment of FIG. 4. The STA 1 affiliated with the STA MLD 1 may be associated with and/or access the AP 1 affiliated with the AP MLD 1, and the STA 2 affiliated with the STA MLD 2 may be associated with and/or access the AP 2 affiliated with the AP MLD 2. Alternatively, at least one of the STA 1, STA 2, AP 1, or AP 2 may not be affiliated with an MLD. Alternatively, all of the STA 1, STA 2, AP 1, and AP 2 may not be affiliated with MLD(s). The AP 1 may configure an R-TWT SP 1, and the AP 2 may configure an R-TWT SP 2. The STA 1 may be a member of the R-TWT SP 1, and the STA 2 may be a member of the R-TWT SP 2. In the time domain, the R-TWT SP 1 and R-TWT SP 2 may overlap (e.g., partially overlap or fully overlap). Communications may be performed simultaneously in some or all of two or more R-TWT SPs.

The R-TWT SP 1 may be indicated by a TWT information element (e.g., R-TWT configuration information) included in a beacon frame transmitted by the AP 1. The R-TWT SP 2 may be indicated by a TWT information element (e.g., R-TWT configuration information) included in a beacon frame transmitted by the AP 2. If the AP 1 and AP 2 are hidden nodes with respect to each other, the AP 1 may not be able to know the R-TWT configuration information of the AP 2, and the AP 2 may not be able to know the R-TWT configuration information of the AP 1. If the R-TWT SP 1 of the AP 1 overlaps with the R-TWT SP 2 of the AP 2, transmissions of the AP 1 and AP 2 within the overlapped R-TWT SPs may collide. In other words, a transmission collision of frames may occur within the overlapped R-TWT SPs.

For example, while the AP 1 transmits a frame (e.g., physical layer protocol data unit (PPDU), physical layer data unit, medium access control (MAC) layer protocol data unit (MPDU), MAC layer data unit, etc.) to the STA 1, the AP 2 may determine a channel to be idle and transmit a frame to the STA 2 on the channel. Since the frame transmission of the AP 1 and the frame transmission of the AP 2 collide, the STA 1 may not be able to decode the frame of the AP 1, and the STA 2 may not be able to decode the frame of the AP 2. Accordingly, the STA 1 may not be able to transmit a reception response frame for the frame of the AP 1, and the STA 2 may not be able to transmit a reception response frame for the frame of the AP 2. In the present disclosure, a reception response frame may be an acknowledgement (ACK) frame or a block ACK (BA) frame.

If a reception response frame is not received from the STA 1, the AP 1 may determine that a transmission collision has occurred and may double enhanced distributed channel access (EDCA) parameter(s). In this case, a latency for channel access of the AP 1 may increase. The EDCA parameter(s) may be a contention window (CW)[access category (AC)] and/or a quick short retry count (QSRC)[AC]. If a reception response frame is not received from the STA 2, the AP 2 may determine that a transmission collision has occurred and may double EDCA parameter(s). In this case, a latency for channel access of the AP 2 may increase.

If reception of a frame fails or if an error occurs in a received frame, each of the STA 1 and STA 2 may perform a channel access operation after waiting for an extended inter frame space (EIFS). The EIFS may be (distributed coordination function (DCF) inter frame space (DIFS)+short inter frame space (SIFS)+AckTxTime). AckTxTime may be the maximum transmission time of an ACK frame or a BA frame. Accordingly, the latency for channel access of each of the STA 1 and STA 2 may increase. The communication latency may increase within the R-TWT SP(s), which are periods for low-latency communication.

Hereinafter, methods for solving the above-described problems will be described. In order to solve the problem of increased communication latency within the R-TWT SP, the STA may report overlap prediction information of R-TWT SP and/or past overlap information of R-TWT SP to the AP. The overlap prediction information may indicate that an R-TWT SP is predicted to overlap. The past overlap information may be information of previously overlapped R-TWT SPs.

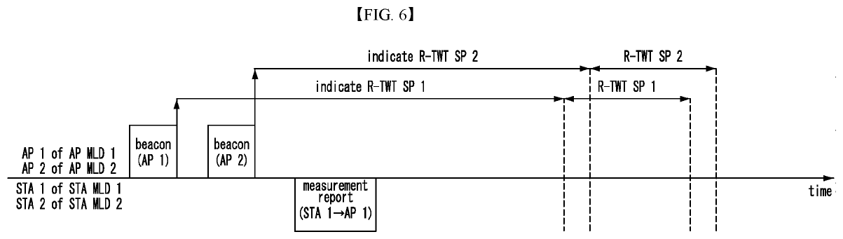

FIG. 6 is a timing diagram illustrating a first exemplary embodiment of an R-TWT SP reporting method in a dense environment.

As shown in FIG. 6, the AP MLD 1, AP MLD 2, AP 1, AP 2, STA MLD 1, STA MLD 2, STA 1, and STA 2 may be arranged identically or similarly to the exemplary embodiment of FIG. 4. The AP MLD 1, AP MLD 2, AP 1, AP 2, STA MLD 1, STA MLD 2, STA 1, and STA 2 may belong to an OBSS. The STA 1 affiliated with the STA MLD 1 may be associated with and/or access the AP 1 affiliated with the AP MLD 1, and the STA 2 affiliated with the STA MLD 2 may be associated with and/or access the AP 2 affiliated with the AP MLD 2. Alternatively, at least one of the STA 1, STA 2, AP 1, or AP 2 may not be affiliated with an MLD. Alternatively, all of the STA 1, STA 2, AP 1, and AP 2 may not be affiliated with MLD(s). The AP 1 may configure an R-TWT SP 1, and the AP 2 may configure an R-TWT SP 2. The STA 1 may be a member of the R-TWT SP 1, and the STA 2 may be a member of the R-TWT SP 2. In the time domain, the R-TWT SP 1 and R-TWT SP 2 may overlap (e.g., partially overlap or fully overlap). Communications may be performed simultaneously in some or all of two or more R-TWT SPs.

The R-TWT SP 1 may be indicated by a TWT information element (e.g., R-TWT configuration information) included in a beacon frame transmitted by the AP 1. The R-TWT SP 2 may be indicated by a TWT information element (e.g., R-TWT configuration information) included in a beacon frame transmitted by the AP 2. The R-TWT SP 1 and/or R-TWT SP 2 may be configured by another frame instead of the beacon frame. The STA 1 may receive the beacon frame of the AP 2. The STA 1 may be configured to identify beacon frame(s) of AP(s) belonging to the OBSS in the R-TWT configuration procedure (e.g., R-TWT setup procedure, R-TWT negotiation procedure) between the STA 1 and the AP 1. As another method, when the STA 1 performs an R-TWT operation (e.g., when the STA 1 participates in the R-TWT SP), the STA 1 may identify beacon frame(s) of AP(s) belonging to the OBSS without a separate configuration or indication.

The STA 1 may receive the beacon frame of the AP 2, and may identify the R-TWT SP 2 based on information elements included in the beacon frame. The STA 1 may identify that the R-TWT SP 1 and R-TWT SP 2 overlap. In this case, the STA 1 may transmit a measurement report frame (e.g., measurement report information) to the AP 1. The measurement report frame may indicate that the R-TWT SPs overlap. The measurement report frame may include information (e.g., address, target beacon transmission time (TBTT)) on the AP 2 and/or the R-TWT configuration information (e.g., TWT information element, Quiet information element) included in the beacon frame of the AP 2. The information included in the measurement report frame may be overlap prediction information. The measurement report frame may be transmitted before the R-TWT SP 1 and/or R-TWT SP 2. Alternatively, the measurement report frame may be transmitted within the R-TWT SP 1 and/or the R-TWT SP 2.

Before transmitting the measurement report frame, the STA 1 may transmit past overlap information to the AP 1. The past overlap information may include information on a frequency and/or the number of times that overlapped R-TWT SPs have occurred previously. The AP 1 may receive the past overlap information from the STA 1, and may allocate an R-TWT SP (e.g., additional R-TWT SP) to the STA 1 based on the past overlap information. The above-described operation may be referred to as ‘additional SP allocation operation’. The additional SP allocation operation may be performed to ensure low-latency data transmission (e.g., low-latency communication) of the STA 1. The STA 2 may operate identically or similarly to the operation of the STA 1 described above. The AP 2 may operate identically or similarly to the operation of the AP 1 described above.

The AP 1 and AP 2 may be affiliated with an AP MLD that supports two or more links. Alternatively, the AP 1 may be affiliated with the AP MLD 1, and the AP 2 may be affiliated with the AP MLD 2. Operations of the AP 1 may be interpreted as operations of the AP MLD 1, and operations of the AP 2 may be interpreted as operations of the AP MLD 2. The STA 1 and STA 2 may be affiliated with a STA MLD that supports two or more links. Alternatively, the STA 1 may be affiliated with the STA MLD 1, and the STA 2 may be affiliated with the STA MLD 2. Operations of the STA 1 may be interpreted as operations of the STA MLD 1, and operations of the STA 2 may be interpreted as operations of the STA MLD 2.

The STA MLD 1 may transmit the measurement report frame to the AP MLD 1 using a multi-link. Alternatively, the STA MLD 1 may transmit the measurement report frame to the AP MLD 1 on a link other than a link on which the beacon frame is received. The AP MLD 1 may perform an additional SP allocation operations on one or more links supported by the STA MLD 1. The STA MLD 2 may operate identically or similarly to the operation of the STA MLD 1 described above. The AP MLD 2 may operate identically or similarly to the operation of the AP MLD 1 described above.

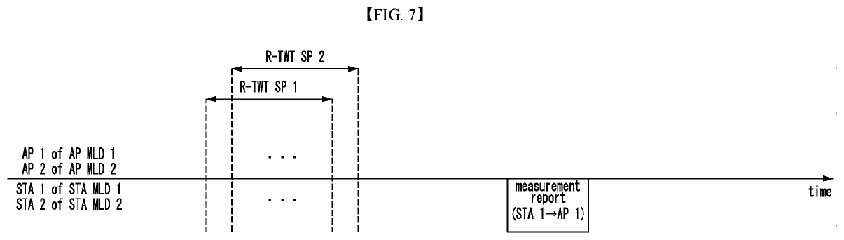

FIG. 7 is a timing diagram illustrating a third exemplary embodiment of an R-TWT SP reporting method in a dense environment.

As shown in FIG. 7, the AP MLD 1, AP MLD 2, AP 1, AP 2, STA MLD 1, STA MLD 2, STA 1, and STA 2 may be arranged identically or similarly to the exemplary embodiment of FIG. 4. The AP MLD 1, AP MLD 2, AP 1, AP 2, STA MLD 1, STA MLD 2, STA 1, and STA 2 may belong to an OBSS. The STA 1 affiliated with the STA MLD 1 may be associated with and/or access the AP 1 affiliated with the AP MLD 1, and the STA 2 affiliated with the STA MLD 2 may be associated with and/or access the AP 2 affiliated with the AP MLD 2. Alternatively, at least one of the STA 1, STA 2, AP 1, or AP 2 may not be affiliated with an MLD. Alternatively, all of the STA 1, STA 2, AP 1, and AP 2 may not be affiliated with MLD(s). The AP 1 may configure an R-TWT SP 1, and the AP 2 may configure an R-TWT SP 2. The STA 1 may be a member of the R-TWT SP 1, and the STA 2 may be a member of the R-TWT SP 2. In the time domain, the R-TWT SP 1 and R-TWT SP 2 may overlap (e.g., partially overlap or fully overlap). Communications may be performed simultaneously in some or all of two or more R-TWT SPs.

The R-TWT SP 1 may be indicated by a TWT information element (e.g., R-TWT configuration information) included in a beacon frame transmitted by the AP 1. The R-TWT SP 2 may be indicated by a TWT information element (e.g., R-TWT configuration information) included in a beacon frame transmitted by the AP 2. The R-TWT SP 1 and/or R-TWT SP 2 may be configured by another frame instead of the beacon frame. The STA 1 may not receive the beacon frame of the AP 2. In other words, the STA 1 may only identify the beacon frame of the AP 1. After the R-TWT SP 1 and R-TWT SP 2 overlap, the STA 1 may recognize that the R-TWT SP 1 and R-TWT SP 2 are overlapped. The STA 1 may determine that the R-TWT SP 1 and R-TWT SP 2 overlap based on at least one of a collision frequency of frames, address field(s) included in MAC header(s) of frame(s) received from communication node(s) (e.g., AP 2 and/or STA 2), or BSS color information included in PHY header(s) of frame(s) received from communication node(s) (e.g., AP 2 and/or STA 2). In this case, the STA 1 may transmit a measurement report frame to the AP 1. The measurement report frame may indicate that the R-TWT SPs (e.g., R-TWT SP 1 and R-TWT SP 2) overlap. The measurement report frame may be transmitted after the R-TWT SP 1 and/or R-TWT SP 2. Alternatively, the measurement report frame may be transmitted within the R-TWT SP 1 and/or R-TWT SP 2.

The STA 1 may be configured to report information on the overlapped R-TWT SPs during an R-TWT configuration procedure (e.g., R-TWT setup procedure, R-TWT negotiation procedure) between the STA 1 and AP 1. As another method, when the STA 1 performs an R-TWT operation (e.g., when the STA 1 participates in the R-TWT SP), the STA 1 may report information on the overlapped R-TWT SPs without a separate configuration or indication. Before transmitting the measurement report frame, the STA 1 may receive the beacon frame of the AP 2, and identify information on the AP 2 included in the beacon frame. As another method, before transmitting the measurement report frame, the STA 1 may transmit a probe request frame to the AP 2, receive a probe response frame from the AP 2 in response to the probe request frame, and identify information on the AP 2 included in the probe response frame. The STA 1 may generate the measurement report frame including the identified information on the AP 2. The measurement report frame may include the information (e.g., address, TBTT) on the AP 2 and/or the R-TWT configuration information (e.g., TWT information element, Quiet information element) included in the beacon frame and/or probe response frame of the AP 2.

Before transmitting the measurement report frame, the STA 1 may transmit past overlap information to the AP 1. The past overlap information may include information on a frequency and/or the number of times that overlapped R-TWT SPs have occurred previously. The AP 1 may receive the past overlap information from the STA 1, and may allocate an R-TWT SP (e.g., additional R-TWT SP) to the STA 1 based on the past overlap information. The above-described operation may be referred to as ‘additional SP allocation operation’. The additional SP allocation operation may be performed to ensure low-latency data transmission (e.g., low-latency communication) of the STA 1. The STA 2 may operate identically or similarly to the operation of the STA 1 described above. The AP 2 may operate identically or similarly to the operation of the AP 1 described above.

The AP 1 and AP 2 may be affiliated with an AP MLD that supports two or more links. Alternatively, the AP 1 may be affiliated with the AP MLD 1, and the AP 2 may be affiliated with the AP MLD 2. Operations of the AP 1 may be interpreted as operations of the AP MLD 1, and operations of the AP 2 may be interpreted as operations of the AP MLD 2. The STA 1 and STA 2 may be affiliated with an STA MLD that supports two or more links. Alternatively, the STA 1 may be affiliated with the STA MLD 1, and the STA 2 may be affiliated with the STA MLD 2. Operations of the STA 1 may be interpreted as operations of the STA MLD 1, and operations of the STA 2 may be interpreted as operations of the STA MLD 2.

The STA MLD 1 may transmit the measurement report frame to the AP MLD 1 using a multi-link. Alternatively, the STA MLD 1 may transmit the measurement report frame to the AP MLD 1 on a link other than a link on which the beacon frame is received. The AP MLD 1 may perform an additional SP allocation operations on one or more links supported by the STA MLD 1. The STA MLD 2 may operate identically or similarly to the operation of the STA MLD 1 described above. The AP MLD 2 may operate identically or similarly to the operation of the AP MLD 1 described above.

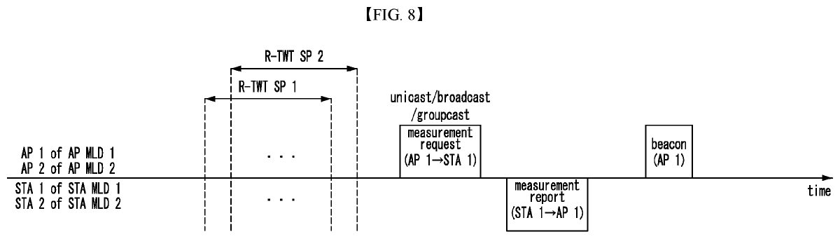

FIG. 8 is a timing diagram illustrating a third exemplary embodiment of an R-TWT SP reporting method in a dense environment.

As shown in FIG. 8, the AP MLD 1, AP MLD 2, AP 1, AP 2, STA MLD 1, STA MLD 2, STA 1, and STA 2 may be arranged identically or similarly to the exemplary embodiment of FIG. 4. The AP MLD 1, AP MLD 2, AP 1, AP 2, STA MLD 1, STA MLD 2, STA 1, and STA 2 may belong to an OBSS. The STA 1 affiliated with the STA MLD 1 may be associated with and/or access the AP 1 affiliated with the AP MLD 1, and the STA 2 affiliated with the STA MLD 2 may be associated with and/or access the AP 2 affiliated with the AP MLD 2. Alternatively, at least one of the STA 1, STA 2, AP 1, or AP 2 may not be affiliated with an MLD. Alternatively, all of the STA 1, STA 2, AP 1, and AP 2 may not be affiliated with MLD(s). The AP 1 may configure an R-TWT SP 1, and the AP 2 may configure an R-TWT SP 2. The STA 1 may be a member of the R-TWT SP 1, and the STA 2 may be a member of the R-TWT SP 2. In the time domain, the R-TWT SP 1 and R-TWT SP 2 may overlap (e.g., partially overlap or fully overlap). Communications may be performed simultaneously in some or all of two or more R-TWT SPs.

The R-TWT SP 1 may be indicated by a TWT information element (e.g., R-TWT configuration information) included in a beacon frame transmitted by the AP 1. The R-TWT SP 2 may be indicated by a TWT information element (e.g., R-TWT configuration information) included in a beacon frame transmitted by the AP 2. The R-TWT SP 1 and/or R-TWT SP 2 may be configured by another frame instead of the beacon frame. The AP 1 and AP 2 may be hidden nodes with respect to each other. In this case, the AP 1 may not identify the beacon frame of the AP 2, and the AP 2 may not identify the beacon frame of the AP 1. Alternatively, even when the AP 1 and AP 2 are not hidden nodes with respect to each other, the AP 1 may not identify the beacon frame of the AP 2, and the AP 2 may not identify the beacon frame of the AP 1.

After the R-TWT SPs (e.g., R-TWT SP 1 and R-TWT SP 2) overlap, the AP 1 may recognize that the R-TWT SPs are overlapped. The AP 1 may determine that the R-TWT SP 1 and R-TWT SP 2 overlap based on at least one of a collision frequency of frames, address field(s) included in MAC header(s) of frame(s) received from communication node(s) (e.g., AP 2 and/or STA 2), or BSS color information included in PHY header(s) of frame(s) received from communication node(s) (e.g., AP 2 and/or STA 2). The AP 1 may transmit a measurement request frame requesting transmission of a measurement report frame to STA(s). The AP 1 may transmit the measurement request frame to a specific STA (e.g., STA 1). Alternatively, the AP 1 may transmit the measurement request frame based on a unicast scheme, a broadcast scheme, or a groupcast scheme. In this case, an address field of the measurement request frame may be set to a unicast address, a broadcast address, or a groupcast address. The measurement request frame may be transmitted after the R-TWT SP 1 and/or R-TWT SP 2 are terminated. Alternatively, the measurement request frame may be transmitted within the R-TWT SP 1 and/or R-TWT SP 2.

The STA 1 may receive the measurement request frame from the AP 1, and may transmit a measurement report frame in response to the measurement request frame. The measurement request frame may indicate occurrence of overlapped R-TWT SPs. If the STA 1 does not identify occurrence of overlapped R-TWT SPs, the STA 1 may transmit the measurement report frame after reception of the measurement request frame of the AP 1. Alternatively, even if the STA 1 identifies occurrence of overlapped R-TWT SPs, the STA 1 may transmit the measurement report frame after reception of the measurement request frame of the AP 1.

The STA 1 may determine that overlapping R-TWT SPs have occurred based on information element(s) included in the measurement request frame. The measurement request frame may request to transmit a measurement report frame including OBSS information and/or information element(s) (e.g., TBTT, TWT information element, Quiet information element) included in a beacon frame and/or a probe response frame transmitted by an AP belonging to the OBSS. In addition, the measurement request frame may include information indicating to transmit a probe request frame to an AP belonging to the OBSS and/or information indicating to receive a beacon frame of an AP belonging to the OBSS.

Before transmitting the measurement report frame, the STA 1 may perform a reception operation of the beacon frame of the AP 2 or a transmission/reception operation of probe request/response frames with the AP 2 according to the indication of the AP 1 included in the measurement request frame. The STA 1 may receive the beacon frame or the probe response frame of the AP 2, and may obtain information on the AP 2 included in the beacon frame or the probe response frame. The STA 1 may generate a measurement report frame including the information on the AP 2. In other words, the measurement report frame may include the information indicated (e.g., requested) by the AP 1

The measurement report frame may include information (e.g., address, TBTT) on the AP 2 and/or the R-TWT configuration information (e.g., TWT information element, Quiet information element) included in the beacon frame or probe response frame of the AP 2. The information included in the measurement report frame may be overlap prediction information. Before transmitting the measurement report frame, the STA 1 may transmit past overlap information to the AP 1. The past overlap information may include information on a frequency and/or the number of times that overlapped R-TWT SPs have occurred previously. The AP 1 may receive the past overlap information from the STA 1, and may allocate an R-TWT SP (e.g., additional R-TWT SP) to the STA 1 based on the past overlap information. The above-described operation may be referred to as ‘additional SP allocation operation’. The additional SP allocation operation may be performed to ensure low-latency data transmission (e.g., low-latency communication) of the STA 1. The STA 2 may operate identically or similarly to the operation of the STA 1 described above. The AP 2 may operate identically or similarly to the operation of the AP 1 described above.

The AP 1 and AP 2 may be affiliated with an AP MLD that supports two or more links. Alternatively, the AP 1 may be affiliated with the AP MLD 1, and the AP 2 may be affiliated with the AP MLD 2. Operations of the AP 1 may be interpreted as operations of the AP MLD 1, and operations of the AP 2 may be interpreted as operations of the AP MLD 2. The STA 1 and STA 2 may be affiliated with an STA MLD that supports two or more links. Alternatively, the STA 1 may be affiliated with the STA MLD 1, and the STA 2 may be affiliated with the STA MLD 2. Operations of the STA 1 may be interpreted as operations of the STA MLD 1, and operations of the STA 2 may be interpreted as operations of the STA MLD 2.

The AP MLD 1 may transmit the measurement request frame to the STA MLD 1 using a multi-link. Alternatively, the AP MLD 1 may transmit the measurement request frame to the STA MLD 1 on a link other than a link on the overlapped R-TWT SPs have occurred. The STA MLD 1 may transmit the measurement report frame to the AP MLD 1 using a multi-link. Alternatively, the STA MLD 1 may transmit the measurement report frame to the AP MLD 1 on a link other than a link on which the beacon frame is received. The AP MLD 1 may perform an additional SP allocation operations on one or more links supported by the STA MLD 1. The STA MLD 2 may operate identically or similarly to the operation of the STA MLD 1 described above. The AP MLD 2 may operate identically or similarly to the operation of the AP MLD 1 described above.

Hereinafter, methods for changing an R-TWT SP based on R-TWT configuration information included in the measurement report frame transmitted by the STA will be described. The methods for changing an R-TWT SP may mean methods for reconfiguring the R-TWT SP. The change of an R-TWT SP may refer to a change in a start time of the R-TWT SP, a change in an end time of the R-TWT SP, a change in a length of the R-TWT SP, a change in a periodicity of the R-TWT SP, and/or a change in a link (e.g., channel) to which the R-TWT SP is applied.

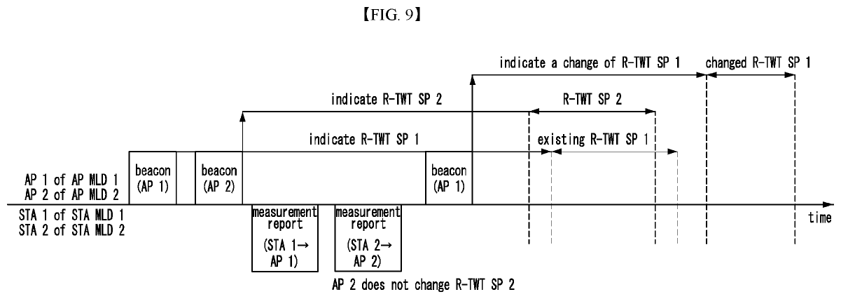

FIG. 9 is a timing diagram illustrating a first exemplary embodiment of a method for changing an R-TWT SP in a dense environment.

As shown in FIG. 9, the AP MLD 1, AP MLD 2, AP 1, AP 2, STA MLD 1, STA MLD 2, STA 1, and STA 2 may be arranged identically or similarly to the exemplary embodiment of FIG. 4. The AP MLD 1, AP MLD 2, AP 1, AP 2, STA MLD 1, STA MLD 2, STA 1, and STA 2 may belong to an OBSS. The STA 1 affiliated with the STA MLD 1 may be associated with and/or access the AP 1 affiliated with the AP MLD 1, and the STA 2 affiliated with the STA MLD 2 may be associated with and/or access the AP 2 affiliated with the AP MLD 2. Alternatively, at least one of the STA 1, STA 2, AP 1, or AP 2 may not be affiliated with an MLD. Alternatively, all of the STA 1, STA 2, AP 1, and AP 2 may not be affiliated with MLD(s).

The AP 1 may transmit a beacon frame including configuration information of an R-TWT SP 1. In other words, the beacon frame of the AP 1 may indicate the R-TWT SP 1. The AP 2 may transmit a beacon frame including configuration information of an R-TWT SP 2. In other words, the beacon frame of the AP 2 may indicate the R-TWT SP 2. The STA 1 may be a member of the R-TWT SP 1, and the STA 2 may be a member of the R-TWT SP 2. The STA 1 may receive the beacon frame of the AP 1 and the beacon frame of the AP 2, and identify the R-TWT SP 1 and the R-TWT SP 2 based on the received beacon frames. The STA 1 may determine that the R-TWT SP 1 and the R-TWT SP 2 overlap, and may transmit a measurement report frame including information on the AP 2 and the R-TWT configuration information of the AP 2 to the AP 1. The STA 2 may receive the beacon frame of the AP 1 and the beacon frame of AP 2, and may identify the R-TWT SP 1 and the R-TWT SP 2 based on the received beacon frames. The STA 2 may determine that the R-TWT SP 1 and the R-TWT SP 2 overlap, and may transmit a measurement report frame including information on the AP 1 and the R-TWT configuration information of the AP 1 to the AP 2. The R-TWT SP 1 and/or R-TWT SP 2 may be configured by another frame instead of the beacon frame.

The AP 1 may receive the measurement report frame of the STA 1 and/or the measurement report frame of the STA 2, and may determine that the R-TWT SP 1 and R-TWT SP 2 overlap based on the received measurement report frame(s). The AP 2 may receive the measurement report frame of the STA 1 and/or the measurement report frame of the STA 2, and may determine that the R-TWT SP 1 and R-TWT SP 2 overlap based on the received measurement report frame(s). When the measurement report frame of the STA 1 is received (e.g., when it is determined that the R-TWT SP 1 and the R-TWT SP 2 overlap), the AP 1 may change the R-TWT SP 1. Alternatively, the AP 1 may change the R-TWT SP 1 even if the AP 1 recognizes that the R-TWT SP 1 and R-TWT SP 2 overlap although the measurement report frame is not received. The R-TWT SP 1 may be changed immediately after reception of the measurement report frame of the STA 1. In other words, the R-TWT SP 1 may be shifted in the time domain.

The AP 1 may transmit a management frame and/or an action frame to change the R-TWT SP 1. For example, to change the R-TWT SP 1, the AP 1 may transmit a beacon frame, probe response frame, and/or TWT frame (e.g., R-TWT frame) indicating a change of the R-TWT SP 1. The frame indicating the change of the R-TWT SP 1 may include R-TWT reconfiguration information (e.g., TWT information element). The AP 1 may change the R-TWT SP 1 so that the R-TWT SP 1 does not overlap with the R-TWT SP 2. In other words, the AP 1 may identify the position and/or length of the R-TWT SP 2 based on information element(s) included in the measurement report frame of the STA 1, and may reconfigure the R-TWT SP 1 so that the R-TWT SP 1 does not overlap with the R-TWT SP 2.

The AP 2 may receive the measurement report frame transmitted by the STA 1 to the AP 1. In other words, the AP 2 may receive the measurement report frame (e.g., the measurement report frame transmitted by the STA 1 to the AP 1) even if a destination of the measurement report frame is not the AP 2. If the measurement report frame of the STA 1 is received before the measurement report frame of the STA 2, the AP 2 may ignore the measurement report frame of the STA 2. The AP 2 may predict that the AP 1 is to change the R-TWT SP 1, and may determine that the R-TWT SP 1 changed by the change of the R-TWT SP 1 does not overlap the R-TWT SP 2. Therefore, the AP 2 may not change the R-TWT SP 2 even if the STA 2 transmits the measurement report frame to the AP 2.

If the AP 1 changes the R-TWT SP 1 based on the measurement report frame of the STA 1, the changed R-TWT SP 1 and the R-TWT SP 2 may not overlap in the time domain. Accordingly, low-latency communication can be performed smoothly within the R-TWT SP. The changed R-TWT SP 1 may mean the reconfigured R-TWT SP 1.

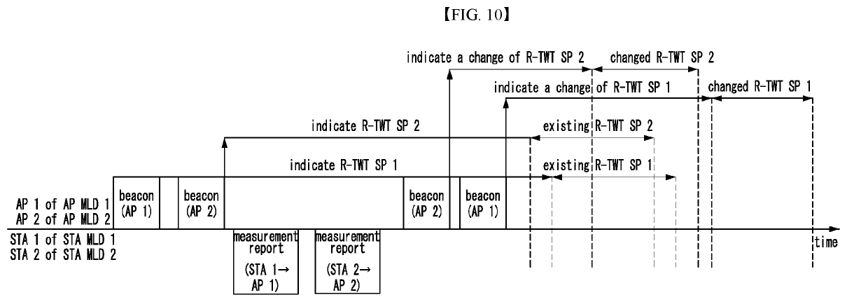

FIG. 10 is a timing diagram illustrating a second exemplary embodiment of a method for changing an R-TWT SP in a dense environment.

As shown in FIG. 10, the AP MLD 1, AP MLD 2, AP 1, AP 2, STA MLD 1, STA MLD 2, STA 1, and STA 2 may be arranged identically or similarly to the exemplary embodiment of FIG. 4. The AP MLD 1, AP MLD 2, AP 1, AP 2, STA MLD 1, STA MLD 2, STA 1, and STA 2 may belong to an OBSS. The STA 1 affiliated with the STA MLD 1 may be associated with and/or access the AP 1 affiliated with the AP MLD 1, and the STA 2 affiliated with the STA MLD 2 may be associated with and/or access the AP 2 affiliated with the AP MLD 2. Alternatively, at least one of the STA 1, STA 2, AP 1, or AP 2 may not be affiliated with an MLD. Alternatively, all of the STA 1, STA 2, AP 1, and AP 2 may not be affiliated with MLD(s).

The AP 1 may transmit a beacon frame including configuration information of an R-TWT SP 1. In other words, the beacon frame of the AP 1 may indicate the R-TWT SP 1. The AP 2 may transmit a beacon frame including configuration information of an R-TWT SP 2. In other words, the beacon frame of the AP 2 may indicate the R-TWT SP 2. The STA 1 may receive the beacon frame of the AP 1 and the beacon frame of the AP 2, and may identify the R-TWT SP 1 and the R-TWT SP 2 based on the received beacon frames. The STA 1 may be a member of the R-TWT SP 1, and the STA 2 may be a member of the R-TWT SP 2. The STA 1 may determine that the R-TWT SP 1 and the R-TWT SP 2 overlap, and may transmit a measurement report frame including information on the AP 2 and the R-TWT configuration information of the AP 2 to the AP 1. The STA 2 may receive the beacon frame of the AP 1 and the beacon frame of the AP 2, and may identify the R-TWT SP 1 and the R-TWT SP 2 based on the received beacon frames. The STA 2 may determine that the R-TWT SP 1 and the R-TWT SP 2 overlap, and may transmit a measurement report frame including information on the AP 1 and the R-TWT configuration information of the AP 1 to the AP 2. The R-TWT SP 1 and/or R-TWT SP 2 may be configured by another frame instead of the beacon frame.

The AP 1 may receive the measurement report frame of the STA 1, and may determine that the R-TWT SP 1 and R-TWT SP 2 overlap based on the received measurement report frame. The AP 2 may receive the measurement report frame of the STA 2, and may determine that the R-TWT SP 1 and R-TWT SP 2 overlap based on the received measurement report frame. When the measurement report frame of the STA 1 is received (e.g., when it is determined that the R-TWT SP 1 and the R-TWT SP 2 overlap), the AP 1 may change the R-TWT SP 1. The R-TWT SP 1 may be changed immediately after reception of the measurement report frame of the STA 1. In other words, the R-TWT SP 1 may be shifted in the time domain. Alternatively, the AP 1 may change the R-TWT SP 1 even if the AP 1 recognizes that the R-TWT SP 1 and R-TWT SP 2 overlap although the measurement report frame is not received. When the measurement report frame of the STA 2 is received (e.g., when it is determined that the R-TWT SP 1 and the R-TWT SP 2 overlap), the AP 2 may change the R-TWT SP 2. The R-TWT SP 2 may be changed immediately after reception of the measurement report frame of the STA 2. In other words, the R-TWT SP 2 may be shifted in the time domain. Alternatively, the AP 2 may change the R-TWT SP 2 even if the AP 2 recognizes that the R-TWT SP 1 and R-TWT SP 2 overlap although the measurement report frame is not received.

The AP 1 may not be aware that the procedure of changing the R-TWT SP 2 is performed by the AP 2. The AP 2 may not be aware that the procedure of changing the R-TWT SP 1 is performed by the AP 1. The R-TWT SP may be changed by a randomization scheme. For example, an offset or/and periodicity of the R-TWT SP may be randomly changed. Accordingly, the changed R-TWT SP 1 of the AP 1 may not overlap with the changed R-TWT SP 2 of the AP 2.

The AP 1 may transmit a management frame and/or an action frame to change the R-TWT SP 1. For example, to change the R-TWT SP 1, the AP 1 may transmit a beacon frame, probe response frame, and/or TWT frame (e.g., R-TWT frame) indicating a change of the R-TWT SP 1. The frame indicating the change of the R-TWT SP 1 may include R-TWT reconfiguration information. The AP 2 may transmit a management frame and/or an action frame to change the R-TWT SP 2. For example, to change the R-TWT SP 2, the AP 2 may transmit a beacon frame, probe response frame, and/or TWT frame (e.g., R-TWT frame) indicating a change of the R-TWT SP 2. The frame indicating the change of the R-TWT SP 2 may include R-TWT reconfiguration information. If the AP 1 changes the R-TWT SP 1 and the AP 2 changes the R-TWT SP 2, the changed R-TWT SP 1 and the changed R-TWT SP 2 may not overlap in the time domain. Accordingly, low-latency communication can be performed smoothly within the R-TWT SP.

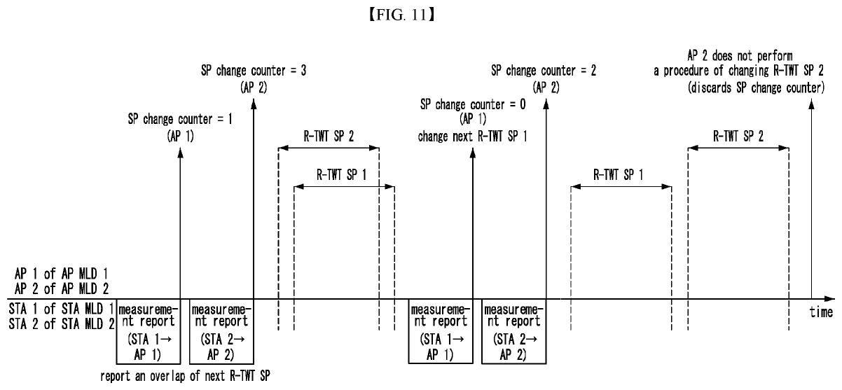

FIG. 11 is a timing diagram illustrating a third exemplary embodiment of a method for changing an R-TWT SP in a dense environment.

As shown in FIG. 11, the AP MLD 1, AP MLD 2, AP 1, AP 2, STA MLD 1, STA MLD 2, STA 1, and STA 2 may be arranged identically or similarly to the exemplary embodiment of FIG. 4. The AP MLD 1, AP MLD 2, AP 1, AP 2, STA MLD 1, STA MLD 2, STA 1, and STA 2 may belong to an OBSS. The STA 1 affiliated with the STA MLD 1 may be associated with and/or access the AP 1 affiliated with the AP MLD 1, and the STA 2 affiliated with the STA MLD 2 may be associated with and/or access the AP 2 affiliated with the AP MLD 2. Alternatively, at least one of the STA 1, STA 2, AP 1, or AP 2 may not be affiliated with an MLD. Alternatively, all of the STA 1, STA 2, AP 1, and AP 2 may not be affiliated with MLD(s).

The AP 1 may transmit a beacon frame including configuration information of an R-TWT SP 1. In other words, the beacon frame of the AP 1 may indicate the R-TWT SP 1. The AP 2 may transmit a beacon frame including configuration information of an R-TWT SP 2. In other words, the beacon frame of the AP 2 may indicate the R-TWT SP 2. The STA 1 may receive the beacon frame of the AP 1 and/or the beacon frame of the AP 2, and may identify the R-TWT SP 1 and the R-TWT SP 2 based on the received beacon frames. The STA 1 may be a member of the R-TWT SP 1, and the STA 2 may be a member of the R-TWT SP 2. The STA 1 may determine that the R-TWT SP 1 and the R-TWT SP 2 overlap, and may transmit a measurement report frame including information on the AP 2 and the R-TWT configuration information of the AP 2 to the AP 1. The STA 2 may receive the beacon frame of the AP 1 and/or the beacon frame of the AP 2, and may identify the R-TWT SP 1 and the R-TWT SP 2 based on the received beacon frames. The STA 2 may determine that the R-TWT SP 1 and the R-TWT SP 2 overlap, and may transmit a measurement report frame including information on the AP 1 and the R-TWT configuration information of the AP 1 to the AP 2. The R-TWT SP 1 and/or R-TWT SP 2 may be configured by another frame instead of the beacon frame.

When the measurement report frame of the STA 1 is received, the AP 1 may determine that the R-TWT SP 1 and the R-TWT SP 2 overlap. Alternatively, the AP 1 may determine that the R-TWT SP 1 and the R-TWT SP 2 overlap without receiving the measurement report frame. In this case, the AP 1 may select an integer within a range [0, M] in a uniform random manner. For example, the AP 1 may select 1. The selected integer may be an SP change counter. M may be a natural number. When the measurement report frame of the STA 2 is received, the AP 2 may determine that the R-TWT SP 1 and the R-TWT SP 2 overlap. In this case, the AP 2 may select an integer within a range [0, N] in a uniform random manner. For example, the AP 2 may select 3. N may be a natural number. M and N may be the same. Alternatively, M and N may be different.

If it is determined that the R-TWT SPs overlap based on the measurement report frame received from the STA or if it is determined that the R-TWT SPs overlap by another method (e.g., a method that does not use the measurement report frame), the SP change counter may be decremented by 1. For example, if the R-TWT SP 1 is predicted to overlap with another R-TWT SP in the future or if the R-TWT SP 1 is determined to have overlapped with another R-TWT SP in the past, the AP 1 may decrement the SP change counter by 1. If the R-TWT SP 2 is predicted to overlap with another R-TWT SP in the future or if the R-TWT SP 2 is determined to have overlapped with another R-TWT SP in the past, the AP 2 may decrement the SP change counter by 1. If the corresponding SP change counter becomes 0, each of the AP 1 and AP 2 may change the R-TWT SP.

The initial SP change counter of the AP 1 may be 1, and the initial SP change counter of the AP 2 may be 3. After the AP 1 selects the SP change counter as 1, if the measurement report frame of the STA 1 is received, the AP 1 may change the SP change counter from 1 to 0. In other words, if the overlap of the R-TWT SP 1 is identified based on the measurement report frame of the STA 1, the AP 1 may change the SP change counter from 1 to 0. If the SP change counter becomes 0, the AP 1 may change the R-TWT SP 1. The AP 1 may change the R-TWT SP 1 so that the R-TWT SP 1 does not overlap with the R-TWT SP 2.

The AP 1 may transmit a management frame and/or an action frame to change the R-TWT SP 1. For example, to change the R-TWT SP 1, the AP 1 may transmit a beacon frame, probe response frame, and/or TWT frame (e.g., R-TWT frame) indicating a change of the R-TWT SP 1. The frame indicating the change of the R-TWT SP 1 may include R-TWT reconfiguration information (e.g., TWT information element).

After the AP 2 selects the SP change counter as 3, if the measurement report frame of the STA 2 is received, the AP 2 may change the SP change counter from 3 to 2. In other words, if the overlap of the R-TWT SP 2 is identified based on the measurement report frame of the STA 2, the AP 2 may change the SP change counter from 3 to 2. Since the AP 1 changed the R-TWT SP 1, the AP 2 may know that the R-TWT SP 2 does not overlap with the changed R-TWT SP 1. Alternatively, the STA 2 may transmit a measurement report frame to the AP 2 that includes information indicating that the R-TWT SP 2 does not overlap with another R-TWT SP (e.g., the changed R-TWT SP 1). The AP 2 may receive the measurement report frame from the STA 2 and may identify that the R-TWT SP 2 does not overlap with another R-TWT SP (e.g., the changed R-TWT SP 1) based on information element(s) included in the measurement report frame. Alternatively, if the R-TWT SP 2 does not overlap with another R-TWT SP (e.g., the changed R-TWT SP 1), the STA 2 may not transmit a measurement report frame to the AP 2. If a measurement report frame of the STA 2 is not received within a preset time or if the R-TWT SP 2 does not overlap with another R-TWT SP (e.g., changed R-TWT SP 1), the AP 2 may discard the SP change counter and may not perform a procedure for changing the R-TWT SP 2.

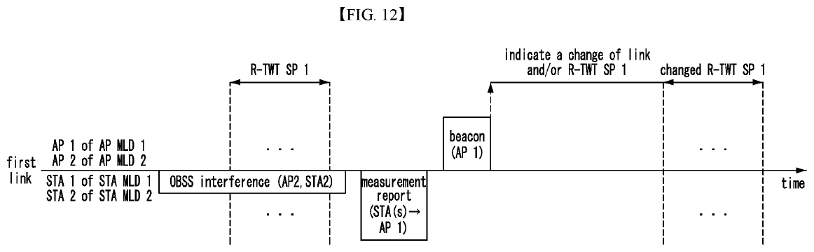

FIG. 12 is a timing diagram illustrating a first exemplary embodiment of a method for changing R-TWT SP(s) and link(s) in a dense environment.

As shown in FIG. 12, the AP MLD 1, AP MLD 2, AP 1, AP 2, STA MLD 1, STA MLD 2, STA 1, and STA 2 may be arranged identically or similarly to the exemplary embodiment of FIG. 4. The AP MLD 1, AP MLD 2, AP 1, AP 2, STA MLD 1, STA MLD 2, STA 1, and STA 2 may belong to an OBSS. The STA 1 affiliated with the STA MLD 1 may be associated with and/or access the AP 1 affiliated with the AP MLD 1, and the STA 2 affiliated with the STA MLD 2 may be associated with and/or access the AP 2 affiliated with the AP MLD 2. Alternatively, at least one of the STA 1, STA 2, AP 1, or AP 2 may not be affiliated with an MLD. Alternatively, all of the STA 1, STA 2, AP 1, and AP 2 may not be affiliated with MLD(s).

A communication node (e.g., AP 2 and/or STA 2) belonging to an OBSS may cause interference to the STA 1. In this case, communication (e.g., low-latency communication) of the STA 1 may not be performed smoothly in the R-TWT SP 1. The STA 1 may not be able to perform communication (e.g., frame transmission and reception operation) smoothly due to interference from a communication node belonging to the OBSS. From the perspective of the AP 1 and/or STA 1, the OBSS interference may be interference caused by communication of the AP 2 and/or STA 2. When the R-TWT SP 1 of the AP 1 overlaps with an R-TWT SP of a communication node belonging to the OBSS, the OBSS interference may occur. When interference occurs within the R-TWT SP 1, the STA 1 may transmit a measurement report frame to the AP 1. The STA 1 may transmit the measurement report frame to the AP 1 without a separate request. For example, if the OBSS interference is detected, the STA 1 may transmit the measurement report frame to the AP 1 without a separate request or separate indication.

The measurement report frame of the STA 1 may include a reason code. The reason code may indicate the OBSS interference and/or the overlap of the R-TWT SPs. The AP 1 may receive the measurement report frame from the STA 1, and may identify occurrence of the OBSS interference and/or the overlapped R-TWT SPs based on the reason code included in the measurement report frame. In this case, the AP 1 may perform a link change operation and/or an R-TWT SP change operation. The link change operation may be an operation of changing an operating frequency of a link. The R-TWT SP change operation may be an operation of changing the R-TWT SP 1 so that an R-TWT SP of a communication node belonging to the OBSS does not overlap with the R-TWT SP 1 of the AP 1. The AP 1 may change the R-TWT SP 1 so that OBSS interference does not occur. The OBSS interference may not occur in the changed R-TWT SP 1. The R-TWT SP change operation may be identical to or similar to at least one of the exemplary embodiments of FIGS. 9 to 11.

The link change operation and/or the R-TWT SP change operation may be indicated by at least one of a management frame or an action frame. For example, the link change operation and/or the R-TWT SP change operation may be performed based on at least one of a beacon frame, a probe response frame, or a TWT frame. The AP 1 may not perform the link change operation and/or the R-TWT SP change operation. Alternatively, the AP 1 may perform one of the link change operation or the R-TWT SP change operation.

As another method, before performing the link change operation and/or the R-TWT SP change operation, the AP 1 may transmit an additional measurement request frame to one or more STAs associated with the AP 1. The additional measurement request frame of the AP 1 may indicate OBSS measurement. The additional measurement request frame may include measurement target information. The measurement target information may indicate at least one of a channel load, OBSS beacon frame, OBSS R-TWT configuration information, or OBSS interference. The OBSS beacon frame may refer to a beacon frame transmitted by a communication node belonging to the OBSS. The OBSS R-TWT configuration information may be R-TWT configuration information (e.g., TWT configuration information) transmitted by a communication node belonging to the OBSS. The OBSS interference may be interference caused by a communication node belonging to the OBSS.

The STA(s) may receive the additional measurement request frame from the AP 1, and perform a measurement operation based on the measurement target information included in the additional measurement request frame. For example, the STA(s) may perform a measurement operation for OBSS. The STA(s) may transmit a measurement report frame including a measurement result to the AP 1. The AP 1 may receive the measurement report frame from the STA(s), and perform the link change operation and/or R-TWT SP change operation based on the measurement result included in the measurement report frame. Alternatively, the AP 1 may not perform the link change operation and/or R-TWT SP change operation. The AP 1 may perform one of the link change operation or R-TWT SP change operation.

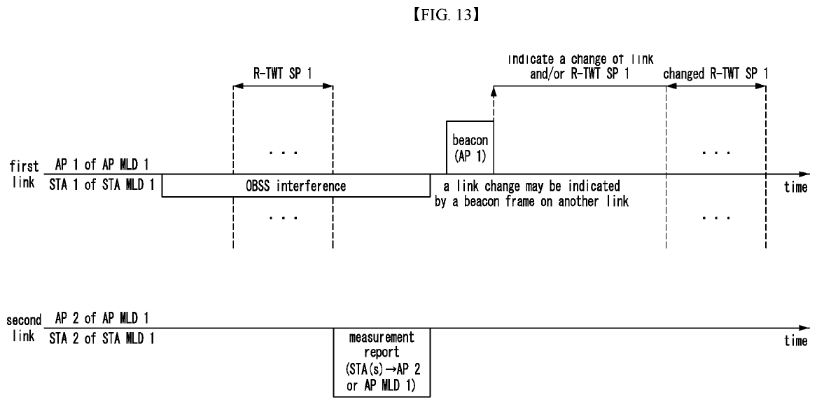

FIG. 13 is a timing diagram illustrating a second exemplary embodiment of a method for changing R-TWT SP(s) and link(s) in a dense environment.

As shown in FIG. 13, the AP 1 and AP 2 may be affiliated with the AP MLD 1, and the AP 1 may operate on a first link and the AP 2 may operate on a second link. The STA 1 and STA 2 may be affiliated with the STA MLD 1, and the STA 1 may operate on the first link and the STA 2 may operate on the second link. The AP MLD 1 (e.g., AP 1 and AP 2) and the STA MLD 1 (e.g., STA 1 and STA 2) may belong to an OBSS. The STA MLD 1 may be affected by OBSS interference on at least one of the first link or the second link. The STA 1 may be affected by the OBSS interference, and communication (e.g., low-latency communication) of the STA 1 may not be performed smoothly in the R-TWT SP 1. The STA 1 may not be able to perform communication (e.g., frame transmission and reception) smoothly due to the OBSS interference.

In this case, the STA MLD 1 may transmit a measurement report frame to the AP MLD 1 using at least one of the first link or the second link. The measurement report frame may be transmitted when the OBSS interference is detected. The STA MLD 1 may transmit the measurement report frame to the AP MLD 1 without a separate request. The measurement report frame may be transmitted using one or more links among multiple links. The STA MLD 1 may transmit the measurement report frame to the AP MLD 1 when the OBSS interference is detected without a separate request or separate indication.

The measurement report frame of the STA MLD 1 may include a reason code. The reason code may indicate the OBSS interference and/or the overlap of R-TWT SPs. The measurement report frame may indicate occurrence of the OBSS interference and/or overlapped R-TWT SPs on the first link. In addition, the measurement report frame may include information indicating a link (e.g., first link) on which the OBSS interference and/or overlapped R-TWT SPs have occurred. The information indicating the link may be a link indicator (e.g., link bitmap). The measurement report frame may be transmitted on the link (e.g., first link) indicated by the measurement report frame or a link (e.g., second link) not indicated by the measurement report frame.

The AP MLD 1 may receive the measurement report frame from the STA MLD 1, and may identify occurrence of the OBSS interference and/or overlapped R-TWT SPs based on the reason code included in the measurement report frame. In addition, the AP MLD 1 may identify a link (e.g., first link) on which the OBSS interference and/or overlapped R-TWT SPs have occurred based on information (e.g., link indicator) included in the measurement report frame. In this case, the AP MLD 1 may perform a link change operation and/or R-TWT SP change operation for the link (e.g., first link) indicated by the measurement report frame. The link change operation may be an operation of changing an operating frequency of the link. The R-TWT SP change operation may be an operation of changing the R-TWT SP 1 so that an R-TWT SP of a communication node belonging to the OBSS does not overlap the R-TWT SP 1 of the AP 1. The R-TWT SP change operation may be the same as or similar to at least one of the exemplary embodiments of FIGS. 9 to 11.

The link change operation and/or the R-TWT SP change operation may be indicated by at least one of a management frame or an action frame. For example, the link change operation and/or the R-TWT SP change operation may be performed based on at least one of a beacon frame, a probe response frame, or a TWT frame. The frame indicating the link change operation may be transmitted on a link other than the link on which the link change operation is performed. The AP MLD 1 may not perform the link change operation and/or the R-TWT SP change operation. Alternatively, the AP MLD 1 may perform one of the link change operation or the R-TWT SP change operation.

As another method, before performing the link change operation and/or the R-TWT SP change operation, the AP MLD 1 may transmit an additional measurement request frame to one or more STAs associated with the AP MLD 1. The additional measurement request frame of the AP MLD 1 may indicate OBSS measurement. The additional measurement request frame may include measurement target information. The additional measurement request frame of the AP MLD 1 may be transmitted on the link(s) indicated by the measurement report frame of the STA MLD 1. The additional measurement request frame of the AP MLD 1 may include a link indicator. The link indicator may indicate the link(s) on which the measurement operation is performed.

The measurement target information may indicate at least one of a channel load, OBSS beacon frame, OBSS R-TWT configuration information, or OBSS interference. The OBSS beacon frame may refer to a beacon frame transmitted by a communication node belonging to the OBSS. The OBSS R-TWT configuration information may be R-TWT configuration information (e.g., TWT configuration information) transmitted by a communication node belonging to the OBSS. The OBSS interference may be interference caused by a communication node belonging to the OBSS.

The STA(s) may receive the additional measurement request frame from the AP MLD 1, and perform a measurement operation based on the measurement target information included in the additional measurement request frame. For example, the STA(s) may perform a measurement operation for OBSS. The STA(s) may transmit a measurement report frame including a measurement result to the AP MLD 1. The AP MLD 1 may receive the measurement report frame from the STA(s), and perform a link change operation and/or R-TWT SP change operation based on the measurement result included in the measurement report frame. Alternatively, the AP MLD 1 may not perform the link change operation and/or R-TWT SP change operation. The AP MLD 1 may perform one of the link change operation or R-TWT SP change operation.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first station (STA), comprising:
identifying a first service period (SP) configured by a first access point (AP) associated with the first STA;
identifying a second SP configured by a second AP;
determining that the first SP overlaps the second SP; and
transmitting a measurement report frame indicating an overlap between the first SP and the second SP to the first AP.

2. The method according to claim 1, wherein the first SP is identified based on first target wake time (TWT) configuration information included in a first beacon frame received from the first AP, and the second SP is identified based on second TWT configuration information included in a second beacon frame or probe response frame received from the second AP.

3. The method according to claim 1, wherein the measurement report frame includes at least one of information on the second AP or second TWT configuration information for the second SP.

4. The method according to claim 1, wherein the measurement report frame is transmitted before the first SP or the second SP if the first SP is predicted to overlap with the second SP, or the measurement report frame is transmitted after the first SP or the second SP if the first SP is determined to overlap with the second SP.

5. The method according to claim 1, further comprising: receiving a measurement request frame from the first AP, wherein the measurement request frame indicates an overlap between the first SP and the second SP, and the measurement report frame is transmitted when the measurement request frame is received.

6. The method according to claim 1, further comprising:
receiving a third beacon frame including TWT reconfiguration information for the first SP from the first AP;
identifying a changed first SP based on the TWT reconfiguration information; and
performing communication in the changed first SP,
wherein the changed first SP does not overlap with the second SP.

7. A method of a first access point (AP), comprising:
transmitting a first beacon frame including first target wake time (TWP) configuration information for a first service period (SP);
receiving a measurement report frame from a first STA indicating an overlap between the first SP and a second SP configured by a second AP; and
transmitting a second beacon frame including TWT reconfiguration information for the first SP,
wherein the first SP changed by the TWT reconfiguration information does not overlap with the second SP.

8. The method according to claim 7, wherein the measurement report frame includes at least one of information on the second AP or second TWT configuration information for the second SP.

9. The method according to claim 7, wherein the measurement report frame is received before the first SP or the second SP if the first SP is predicted to overlap with the second SP at the first STA, or the measurement report frame is transmitted after the first SP or the second SP if the first SP is determined to overlap with the second SP at the first STA.

10. The method according to claim 7, further comprising: in response to determining that the first SP and the second SP overlap, transmitting a measurement request frame, wherein the measurement report frame is received as a response to the measurement request frame.

11. A method of a first station (STA), comprising:
identifying a first service period (SP) configured by a first access point (AP) associated with the first STA;
detecting overlapped basic service set (OBSS) interference in the first SP; and
transmitting a measurement report frame indicating occurrence of the OBSS interference to the first AP.

12. The method according to claim 11, wherein the first SP is identified based on first target wake time (TWT) configuration information included in a first beacon frame received from the first AP, and the OBSS interference is caused by a communication node belonging to an OBSS.

13. The method according to claim 11, wherein the measurement report frame includes a reason code, and the reason code indicates occurrence of the OBSS interference.

14. The method according to claim 11, further comprising:
receiving a second beacon frame including TWT reconfiguration information for the first SP from the first AP;
identifying a changed first SP based on the TWT reconfiguration information; and
performing communication in the changed first SP,
wherein the OBSS interference does not occur in the changed first SP.
